(19) United States
(12) Patent Application Publication
(10) Pub. No.: US 2018/0285123 A1
(43) Pub. Date: Oct. 4, 2018

(54) CONTROLLER CONSOLIDATION, USER MODE, AND HOOKS IN RACK SCALE ARCHITECTURE

(71) Applicant: Intel Corporation, Santa Clara, CA (US)

(72) Inventors: Mohan J. Kumar, Aloha, OR (US); Murugasamy K. Nachimuthu, Beaverton, OR (US)

(73) Assignee: Intel Corporation, Santa Clara, CA (US)

(21) Appl. No.: 15/473,220

(22) Filed: Mar. 29, 2017

(51) Int. Cl. G06F 9/445; G06F 13/38; G06F 9/22

(52) U.S. Cl. CPC G06F 9/445; G06F 9/22; G06F 8/66; G06F 13/385

(57) ABSTRACT

A rack system includes a plurality of compute nodes can implement controller consolidation, a definition of a user mode, and/or debuggability hooks. In the controller consolidation, a plurality of nodes each include a minicontroller to communicate with a baseboard management controller. The baseboard management controller manages the nodes through communication with the minicontrollers. In the definition of a user mode, a compute node receives a request for an update and blocks the update, based on a determination that the update is to firmware of the compute node, to prevent an inband Basic Input/Output System (BIOS) update in a composed system in a rack scale environment. With the debuggability hooks, a processor receives from one of a plurality of processing cores a first message including a first POST code and either a first identifier of a first processing core or a second identifier of a second processing core.

### TECHNICAL FIELD OF THE DISCLOSURE

The present disclosure relates generally to a rack system including a plurality of compute nodes (also called blades or sleds), and, more particularly, to controller consolidation, definition of a user mode, and debuggability hooks in such a rack system.

### BACKGROUND

Disaggregated computing is an emerging field based on the pooling of resources. One disaggregated computing solution is known as rack scale architecture (RSA).

Conventionally, each compute node in a rack has a baseband management controller (BMC).

Further, a user typically enters into a Service Level Agreement (SLA) with the owner of a rack to access resources of the rack. In the SLA, the rack owner agrees to provide the user with a particular level of service, such as a number of compute nodes that can perform a certain number of operations per second, can access a particular amount of memory, and/or can access a specific amount of network bandwidth. However, because the owner of the rack does not configure the resources available to a compute node for each SLA, the compute node commonly has additional resources beyond those defined in the SLA.

Once agreement is reached regarding the SLA, the user gets access to a bare metal system. In a conventional rack, the user can update the compute system firmware. The firmware is software programmed into a read-only memory (ROM), for example. The firmware can be Basic Input/Output System (BIOS), a management engine (ME), the BMC, dual in-line memory module (DIMM) firmware, and storage drive firmware.

Sometimes, once the user updates the firmware, the user cannot downgrade the version of the firmware. The user's inability to downgrade the version of the firmware leads to the system administrator getting back the system with un-validated firmware components. In this case, the system administrator might not be able to allocate the system to another user to meet the other user's SLA.

In addition, code conventionally is written into portions of the system's boot code to indicate successful completion of different portions of the boot code. For example, the BIOS can use Port 80 to write a code that represents the progress made during a Power-On Self Test (POST). If a portion of the POST fails, Port 80 retains the last POST code generated. Thus, this last generated POST code can indicate the failed portion of the POST.

### BRIEF DESCRIPTION OF THE DRAWINGS

FIG. 1 illustrates an implementation of a rack according to the present disclosure;

FIG. 2 illustrates an implementation of a system including a “super” BMC and a plurality of compute nodes according to the present disclosure;

FIG. 3 illustrates an algorithm for a cooling operation performed by an implementation of the present disclosure;

FIG. 4 illustrates an algorithm for updating a computer node in accordance with one implementation of the present disclosure; and

FIG. 5 shows an implementation of an algorithm including BIOS debuggability hooks.

### DESCRIPTION OF EXAMPLE EMBODIMENTS OF THE DISCLOSURE

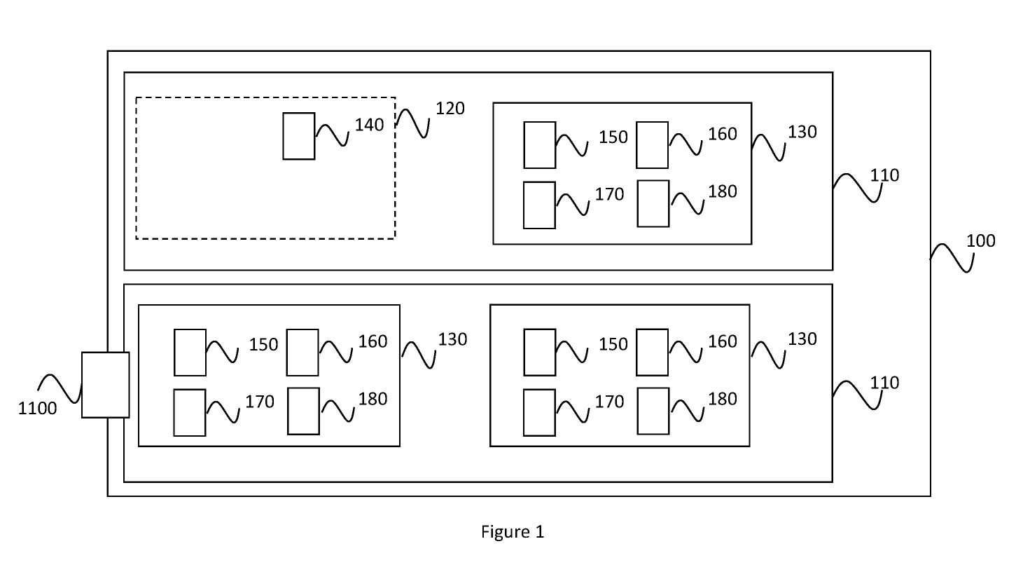

FIG. 1 illustrates an implementation of a rack 100 according to the present disclosure.

In many implementations, the rack 100 operates in a software-defined infrastructure (SDI). In an SDI, an executed application and its service level define the system requirements. An SDI enables a data center to achieve greater flexibility and efficiency by being able to dynamically “right-size” application resource allocation, enabling provisioning service in minutes and significantly reducing cost.

The rack 100 interfaces with an orchestration layer. The orchestration layer is implemented in software that runs on top of a POD manager in the disclosed rack scale design context. The POD manager manages a POD, which is a group of one or more racks commonly managed by the POD manager.

The orchestration software provisions, manages and allocates resources based on ongoing data provided to the orchestration software by service assurance layers. More specifically, the orchestration software is responsible for providing resources, such as pooled resources (e.g., compute resources, network resources, storage resources), database resources, as well as composing and launching application or workloads, and monitoring hardware and software. Although the orchestration layer need not be included in the rack 100, the orchestration layer is so included in at least one implementation. The orchestration layer includes or is executed by hardware logic. The hardware logic is an example of an orchestration means.

Intelligent monitoring of infrastructure capacity and application resources helps the orchestration software make decisions about workload placement based on actual, current data as opposed to static models for estimated or average consumption needs based on historical data.

The rack includes a plurality of drawers 110. Each drawer 110 includes node slots 120, sensors, and nodes 130. In the present example, nodes 130 are compute nodes. However, nodes can be storage nodes, field-programmable gate array (FPGA), etc.

The node slots 120 accept compute nodes 130 for insertion. FIG. 1 illustrates two drawers including a total of one vacant node slot 120 and three node slots filled by compute nodes 130. Of course, this illustration is simply for exemplary purposes and in no way limits implementations of this disclosure. For example, all of the node slots can be filled by compute nodes 130. In addition, each drawer 110 can have fewer or more slots.

The node slots 120 include structures for mounting the compute nodes 130 within a drawer 110. The node slots 120 additionally include wiring to provide power and other signals (e.g., a fan power signal) to the compute nodes 130.

The node slots 120 include a sensor 140 that indicates when and whether a compute node 130 has been inserted into the respective node slot. The sensor 140 can transmit a signal to the orchestration layer or a “super” BMC indicating the insertion of a compute node 130.

The sensors include sensors 150. The sensors 150 measure temperatures within the compute nodes 130. The sensors 150 transmit their measurements to the controller 170. The sensors 150 are examples of a sensing means.

The controller 170 receives the transmitted measurements from the sensors 150. The controller 170 controls aspects of the compute nodes 130 based on measurements sensed by the sensors 150. The controller 170 also performs the processing of a job assigned to the compute node 130 in an SLA.

The controller 170 can be a BMC or a portion of the orchestration layer. The controller 170 includes a cache memory. The controller 170 is an example of a processing means.

The controller 170 can access additional memory 160 on the compute node 130. This additional memory is an example of a storing means.

The compute node 130 can also include a fan 180. The fan 180 is an example of a cooling means.

The drawer 110 also include a vent 1100. For clarity of illustration, only one drawer 110 is shown with a vent 1100. However, this illustration is not limiting. For example, the drawer can have additional vents, such as on a side of the drawer 110 opposing vent 1100. In some implementations, one or more sides of the drawer include multiple vents. The vent 1100 is an example of a venting means.

In one implementation, the compute nodes include nonvolatile memory or solid state drives. The compute nodes can also include networking resources.

In different implementations, the cache memory in controller 170, the additional memory 160, the nonvolatile memory, and the solid state drives are each an example of a memory element. The memory elements store electronic code that can be executed by a control 170. The code, when executed, performs operations associated with the algorithms set forth herein.

Consolidated BMC for Multi-System Support

In one implementation of the present disclosure, a plurality of nodes (e.g., compute nodes) in a rack include a minicontroller instead of the BMC (e.g., controller 170) conventionally included in each node. In a particular implementation, every node in a rack includes a minicontroller. The rack itself can include a “super” BMC that supports multiple systems as detailed below.

In many implementations, the minicontroller is less expensive than the conventionally-included BMC. Thus, the expense of a node can be decreased. Accordingly, by replacing several BMCs with minicontrollers, the total cost of ownership (TCO) of a system can be reduced by including a “super” BMC in a rack or a drawer.

The scope of the minicontroller is not limited to those less expensive than a BMC, as different implementations can achieve different advantages with different minicontrollers. For example, the distribution of the processing achieved by a “super” BMC along with more expensive minicontrollers can still provide an improvement over conventional implementations. Additional advantages will become clear from the following description.

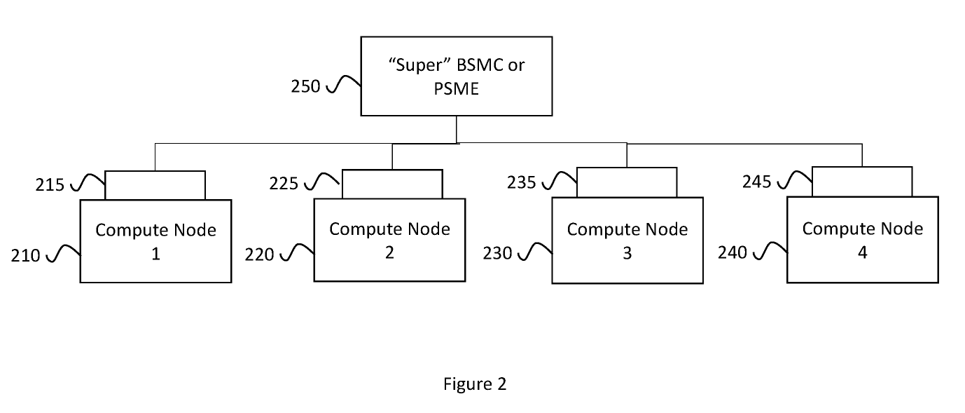

FIG. 2 illustrates an implementation of a system including a “super” BMC and a plurality of compute nodes 130. FIG. 2 can be, but is not necessarily, implemented in conjunction with FIG. 1. As shown in FIG. 2, the system includes compute nodes 210, 220, 230, and 240. Each of the compute nodes includes a minicontroller. Thus, compute node 210 includes minicontroller 215, compute node 220 includes minicontroller 225, compute node 230 includes minicontroller 235, and compute node 240 includes minicontroller 245.

The “super” BMC 250 can structurally be a conventional BMC. However, the operation of the “super” BMC 250 differentiates the “super” BMC 250 from a conventional BMC.

The “super” BMC 250 can communicate with and control the plurality of the minicontrollers 215, 225, 235, and 245 in a drawer or a rack. Typically, the “super” BMC 250 communicates with and controls all of the minicontrollers in a drawer or a rack.

The minicontrollers 215, 225, 235, and 245 are communicatively coupled to “super” BMC 250 by an interface. The interface between the “super” BMC and the minicontrollers can be a system management bus (SMBus), an Ethernet interface, or a proprietary interface. Thus, the minicontrollers can communicate with the “super” BMC using the SMBus, the Ethernet interface, or the proprietary interface. Thus, in one implementation, the “super” BMC and the minicontrollers share data to perform a job defined by an SLA.

Generally, the keyboard, video and mouse (KVM) are not connected in Rack Scale Design. The KVM are generally redirected over Ethernet or a network. A user can connect a keyboard, video, or a mouse, or use Serial Over LAN (SOL) to see system messages and control the system. Thus, in certain implementations, the system selects one interface at a time to accommodate a keyboard, video, and mouse (KVM).

The “super” BMC 250 can be or include a Pool System Management Engine (PSME) by Intel Corporation. A PSME is an RSA-level management engine/logic for managing, allocating, and/or re-allocating resources at the rack level.

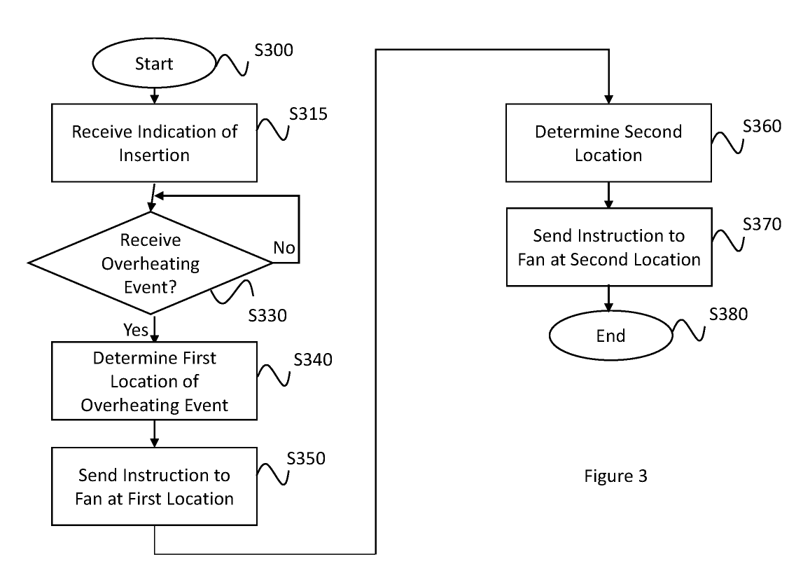

FIG. 3 illustrates an algorithm for a cooling operation performed by an implementation of the present disclosure. FIG. 3 can be, but is not necessarily, implemented in conjunction with FIGS. 1-2. The algorithm begins at S300 and proceeds to S315.

In S315, the “super” BMC receives an indication from a sensor (e.g., sensor 140) that a compute node (e.g., compute node 130) has been inserted into a slot (e.g., slot 120) in the rack (e.g., rack 100). In some implementations, the sensor is coupled to the slot such that the “super” BMC can communicate directly with the compute node. In other implementations, the indication includes an identifier of the slot, of the minicontroller on the inserted compute node, and/or of the inserted compute node. When the “super” BMC communicates with the compute node, the “super” BMC can communicate using the identifier of the slot and/or the compute node.

As explained previously, a rack can include a plurality of drawers, and a plurality of the drawers can include a plurality of slots. Thus, in an implementation in which each slot includes a sensor, the “super” BMC can receive a plurality of indications from the plurality of sensors or the minicontrollers at S315.

The “super” BMC can determine the relative positions of the compute nodes based on these indications (e.g., that a first compute node is in a lower drawer of the rack than a second compute node in an upper drawer of the rack).

Of course, other implementations are possible, as well. For example, the “super” BMC can receive from a sensor an indication that an unidentified slot in an identified drawer includes a compute node. That is, the “super” BMC need not know the specific slot in which the compute node is inserted.

Once the super “BMC” receives an indication as described above, the algorithm advances to S330.

In S330, the “super” BMC determines whether it has received an indication of an overheating event from a sensor (e.g., sensor 150) or from a minicontroller (e.g., minicontroller 215). If the “super” BMC determines that it has not yet received an indication of an overheating event (such as a temperature of the compute node exceeding a predetermined threshold), then the algorithm returns to S330. On the other hand, if the “super” BMC determines that it has received an indication of the overheating event, then the algorithm advances to S340. The overheating event indication can simply indicate the overheating as determined by the minicontroller. In another implementation, the indication can include a temperature value. Thus, the “super” BMC can itself determine whether the overheating event has occurred by determining whether the temperature value in the indication exceeds a predetermined threshold.

In S340, the “super” BMC determines a location of an overheating event as a first location. The “super” BMC can determine this first location based on an identifier included in the indication of the overheating event received at S330, for example. In other implementations, the indication of the overheating event need not include the identifier. For example, the “super” BMC can determine the first location based on a particular interface over which the indication was received. In many implementations, the first location is a particular slot in a drawer or a rack controlled by the “super” BMC. However, the first location need not be so limited. For example, in some implementations, the first location can simply be a particular drawer of a rack.

After the “super” BMC determines the first location, the algorithm then advances to S350.

In S350, the “super” BMC sends an instruction to a fan at the first location. The instruction can include the identifier included in the indication received at S340. In other implementations, the instruction is merely sent over the particular interface determined in S340. In one implementation, the instruction instructs the compute node at the first location to power the fan. In some implementations, the instruction instructs the compute node at the first location to increase the speed of the fan or otherwise control the fan. The algorithm then advances to S360.

In S360, the “super” BMC determines a fan to be operated at a second location. In one implementation, the second location is a slot adjacent to the first location determined at S340. Operating a fan at a slot adjacent to the first location can increase the heat dissipation in the area proximal to the overheating event. Thus, a more effective cooling operation can be provided.

In another implementation, the second location is a slot non-adjacent to the first location but in the same drawer. In such an implementation, the second location can be opposite a vent (e.g., vent 1100) in a housing of the rack, relative to the first location. Operating a fan in the second location can increase the airflow past the first location and through the vent. Thus, a more effective cooling operation can be provided.

In yet another implementation, the second location is in a drawer above the drawer including the first location. A portion of the excess heat will rise from the first location to the upper drawer. Accordingly, compute nodes in the upper drawer also are at risk of overheating. The “super” BMC can proactively address this problem by operating a fan in the upper drawer to increase the heat dissipation in that drawer.

After the “super” BMC determines the second location, the algorithm then advances to S370.

In S370, the “super” BMC sends an instruction to a fan at the second location. The instruction can include an identifier included in an indication received at S315. In other implementations, the instruction is merely sent over a particular interface that communicated an identifier at S315. In one implementation, the instruction instructs a compute node at the second location to power a local fan. In some implementations, the instruction instructs the compute node at the second location to increase the speed of the fan or otherwise control the fan. The algorithm then concludes at S380.

Preventing Inband Firmware Update

As discussed previously, a rack can comprise bare metal systems. The system allows the user to query the compute node for its current resources and to update the compute system firmware. A compute node according to at least one implementation of the present disclosure distinguishes between a user mode and an administrator mode.

In one aspect, the administrator mode maintains the ability to query the system for the (accurate) current resources of the system, as well as the ability to update the compute system firmware. In contrast, the user mode modifies how the system reports the current resources of the system to the user.

Often, a service provider assigns a user resources in excess of those defined in the SLA. If the user becomes aware of these excess resources, the rack might not prevent the user from making use of these resources. Thus, the user improperly might obtain a higher level of service than the service for which the user agreed to pay in the SLA.

Thus, if a compute node responds accurately to a user's query of the system's current resources, there is a risk that the user improperly will receive a higher level of service than that for which the user agreed to pay.

A compute system can receive a query by a keyboard, a mouse, over a network interface, or from a locally executing application. Thus, in response to such a query, some implementations of the user mode provide to the user an indication of a lesser amount of resources than those actually available to the compute node. One such implementation informs the user with an indication of resources equal or slightly greater (e.g., <10% greater) than those defined by the SLA. For example, the indication can inform the user about the number of operations per second, a particular amount of memory, and/or a specific amount of network bandwidth defined by the SLA. The indication can be provided, e.g., over a display or can be transmitted over a network interface.

In addition, the system restricts (e.g., prohibits) updating the computer system firmware while in the user mode.

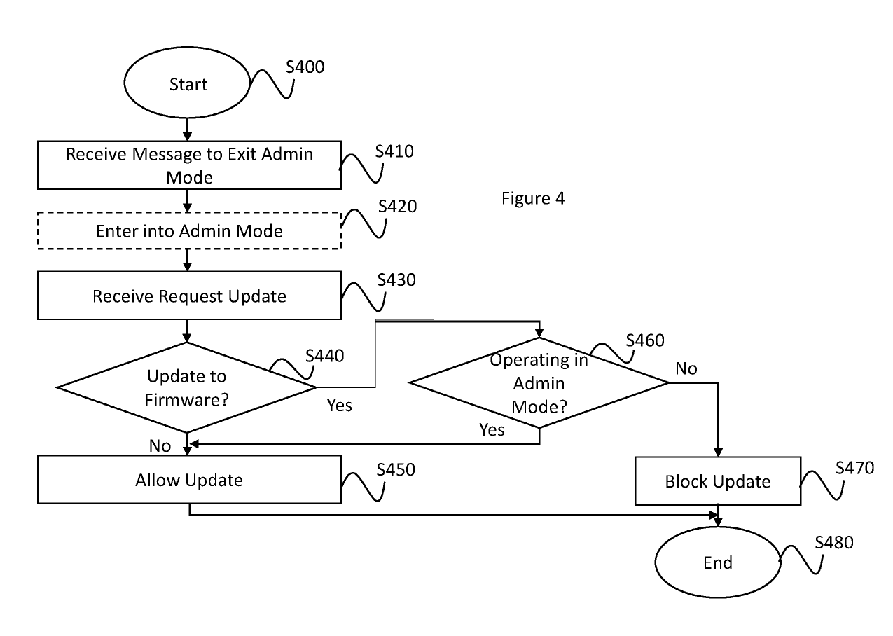

FIG. 4 illustrates an algorithm for updating the computer system in accordance with one implementation of the present disclosure. FIG. 4 can be, but is not necessarily, implemented in conjunction with FIG. 1.

The algorithm begins at S400 and proceeds to S410. At S410, the compute node receives an out-of-band message to inform the compute node to exit out of administrator mode. For example, the system enters into user mode. After the compute node enters into user mode, the compute node acknowledges the entry into user mode via an out-of-band message. The algorithm then advances to S420.

Substantial additional processing can be performed between S410 and S420, such as performance of a job at a predetermined service level. Such additional processing is outside the scope of the present disclosure and, therefore, additional explanation is omitted.

At S420, the compute node optionally authorizes entry from the user mode into the administrator mode. For example, a user can optionally access the administrator mode via authentication, such as by entering a password and, optionally, a login. Of course, the compute node can implement additional or alternative authentication methods, such as biometric authentication. Many authentication options are possible and are outside the scope of the present disclosure. The algorithm then advances to S430.

At S430, the compute node receives a requested update. The update can be requested by a user, for example. The requested update might update software of the compute node. The software might additionally or alternatively update firmware of the compute node. The algorithm then advances to S440.

At S440, the compute node determines whether the update received in S430 is to firmware of the compute node.

If the compute node determines at S440 that the requested update is to firmware of the compute node, then the algorithm advances to S460. At S460, the compute node determines whether it is operating in the administrator mode.

If the compute node determines at S460 that it is operating in the administrator mode, then the algorithm advances to S450.

On the other hand, if the compute node determines at S460 that it is not operating in the administrator mode, then the algorithm advances to S470.

In addition, if the compute node determines at S440 that the requested update is not to the firmware of the compute node, then the algorithm advances to S450.

In S450, the compute node allows the update request received at S430, and the compute node performs the requested update. That is, if the compute node determines in S440 that the update is not to firmware of the compute node, then the compute node allows and performs the non-firmware upgrade at S450. Alternatively, if the compute node determines in S460 that it is operating in the administrator mode, then the compute node allows and performs the requested update in S450, even though the update requested in S430 is to firmware of the compute node. The algorithm then advances to S480.

In S470, the compute node blocks the update requested in S430. Thus, the system administrator can avoid a problem in which she cannot downgrade the firmware of the compute node from un-validated firmware components. The algorithm then advances to S480.

In S480, the algorithm concludes.

In the illustrated implementation, the system begins the algorithm in administrator mode and sends an out-of-band message to exit from administrator mode in SL10. In another implementation, the system simply does not begin in administrator mode. That is, the system can begin in user mode. Thus, the out-of-band message is not necessarily sent in S410.

BIOS Debuggability Hooks

The BIOS is a set of instructions stored in memory executed by a processor. More specifically, the BIOS is a type of firmware that performs a hardware initialization during a booting process (e.g., power-on startup). The BIOS also provides runtime services for operating systems and programs.

As discussed previously, boot code conventionally includes codes that indicate successful execution of different portions of the boot code. Thus, when a system hangs, these codes indicate the identity of the hanging portion of the boot code. One example of these codes are Port 80 codes. In many implementations, these codes are hexadecimal values. Generally, the Port 80 code distinguishes between an error in the system and a functioning of the system. However, there is no standard for the port 80 numbers.

A problem arises in a rack scale architecture that, when a processing core hangs, the identity of the hanging processing core is unknown. This identity of the core is unknown, because Port 80 generally has only 1 byte of information. A single byte of information can indicate only 256 values. However, if a system has 8 sockets, and each processor socket has 48 cores, then the total number of cores is 384. One byte of information is insufficient to distinguish between that many cores.

Thus, in an implementation of the present disclosure, each processing core is assigned a different Advanced Programmable Interrupt Controller (APIC) identifier (ID). The system BIOS can assign a respective APIC ID to each core in a particular socket, during initialization at boot-up. Thus, the system BIOS can make sure each APIC ID is different across the system. The BIOS, during execution, can communicate the APIC ID and the physical processor mapping (e.g., socket number and actual physical core number within the socket) to the BMC to provide to a POD manager to provide serviceability information.

In an implementation of the present disclosure, one core is selected to be the bootstrap processor at startup. The bootstrap processor begins execution of the system BIOS. The system BIOS executing upon the bootstrap processor launches the OS.

The system BIOS, during execution by the bootstrap processor, sends the APIC IDs of the cores to the OS, which runs on all of the processors in a socket. Thus, the OS can identify each processing core by its APIC ID.

Thus, rather than use a one or two byte code, a code according to some implementations of the present disclosure includes the APIC ID, a 32-bit number indicating the functionality/code segment of the code, as well as another 32-bit number corresponding to a “string/text” portion having more numbers or specific information about the startup progress.

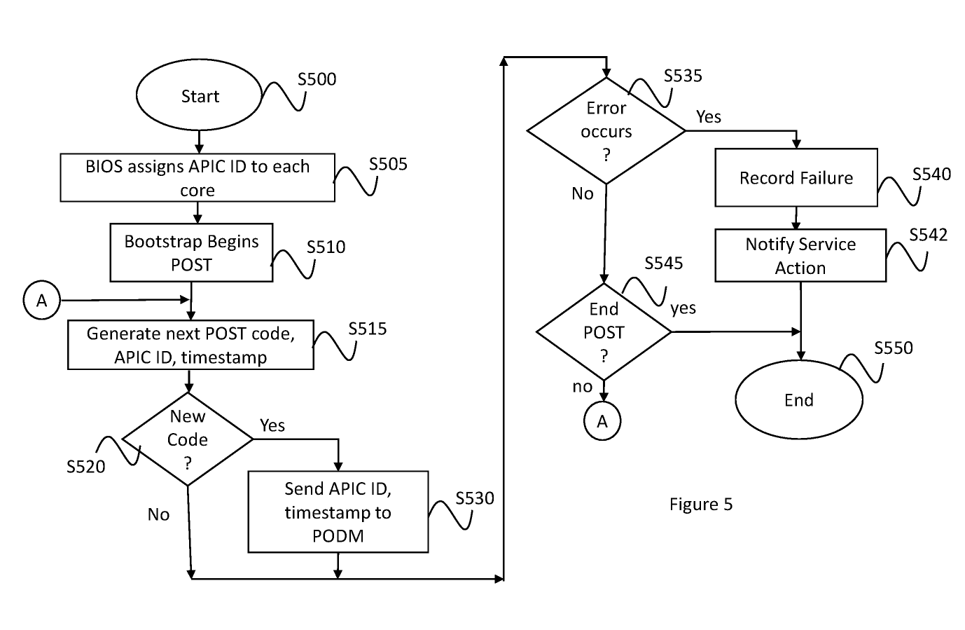

FIG. 5 shows an implementation of an algorithm including BIOS debuggability hooks. FIG. 5 can be, but is not necessarily, implemented in conjunction with FIG. 1. The algorithm begins at S500 and advances to S505, in which the system BIOS, as executed by at least the bootstrap processor, assigns an APIC ID to each processing core during initialization at bootup. The algorithm then advances to S510.

At S510, the bootstrap processor begins the POST. While the bootstrap processor executes the POST, the algorithm advances to S515.

At S515, during its respective POST, each processing core generates an indication of its next POST code, the APIC ID of the processing core, and a timestamp of the current time.

More specifically, the BIOS executed by each processing core generates the POST code based on a functionality the BIOS is currently executing. Sometimes, the BIOS generates the POST code based which code segment the BIOS is executing. As discussed previously, the POST code can be a 32-bit number indicating the executing functionality/code segment.

Each processing core then transmits that indication to a management controller or the BMC. The management controller or the BMC receives the indication.

Thus, the transmitted indication can be considered a progress code. The progress code also can contain the text messages to provide additional information. As discussed previously, the text messages in some implementations can be a 32-bit number having more numbers or information about the startup progress. The algorithm then advances to S520.

At S520, the management controller or the BMC determines whether the progress code received at S515 is new. That is, the management controller or the BMC first extracts the APIC ID from the received indication. The management controller or the BMC identifies a previous indication including the same APIC ID and a timestamp immediately preceding the timestamp in the indication received at S515. The management controller or the BMC compares the progress code received at S515 to a previous progress code received with the previous indication. The management controller or the BMC then determines whether the progress code received in S515 is different from the previous progress code.

If the management controller or the BMC determines in S520 that the progress code received in S515 is different from the previous progress code, then the algorithm advances to S530. In S530, the management controller or the BMC sends the indication received in S515 to the pod manager (PODM) of the rack. The POD manager receives this indication, if the POST has not completed. The algorithm then advances to S535.

The PODM is the software and firmware that exposes the hardware underneath it to the orchestration layers above it that manage and enforce policies. The pod manager includes firmware and a software application program interface (API) that enables managing resources and policies across and exposes a standard interface to hardware below the pod manager and the orchestration layer above it. The Pod Manager API allows usage of rack scale architecture (RSA) system resources in a flexible way and allows integration with ecosystems where the RSA is used. The pod manager enables health monitoring and problem troubleshooting (e.g., faults localization and isolation) and physical localization features.

If the management controller or the BMC determines in S520 that the progress code received in S515 is not different from the previous progress code, then the algorithm advances to S535.

In S535, the system (e.g., the processing core, the BMC, the PODM, or the BIOS) determines whether an error has occurred.

In one implementation, the system determines a difference between a time in the timestamp in a first message with the received APIC ID and a time in the timestamp in a second message received from the same APIC ID. In some implementations, the first message immediately precedes the second message. In other implementations, there are intervening messages received from the same APIC ID.

Although this difference is not generally displayed to the user, the difference can be displayed via a display to inform a user of an extent of a delay. The difference can also or alternatively be transmitted over a network interface.

In particular implementations, the POD manager or a root cause analysis determines the cause of the problem based on the difference. The POD manager or the root cause analysis then informs the problem to the user (e.g., via a display) for an appropriate action to be taken to fix the issue.

In one implementation, the POD manager generates a notification indicating that a sled of the first processing core or a sled of the second processing core has an error, if the difference is greater than a predetermined time based on historical data. The POD manager determines the historical data based on a POST code in the first or second message. More specifically, the historical data pertains to time differences for the same POST code on at least one previous boot.

In some implementations, once the POD manager determines the difference is greater than the predetermined time, the POD manager determines differences between times in other timestamps from the same APIC ID as well. In this way, the POD manager can determine whether an earlier issue has caused a cascading effect.

For example, the POD manager watches how much time an operation corresponding to each POST code is taking. The POD manager can compare this amount of time to a predetermined period of time based on historical data on previous boots. If a predetermined sequence of POST codes takes more time than expected, then the POD manager flags that the compute SLED executing those POST codes has an error.

Also, the POD manager can determine the nature of the error by analyzing SLED configuration changes or the APIC ID (corresponding to the core executing the BIOS POST) and the time the SLED took on each POST code.

In one example, if a system takes more time to initialize the memory than expected, the chances are either the memory subsystem or the memory link has an error or that additional memory has been added to the system. Similarly, if the APIC ID changes, the core or the processor cache might have an error, and a Fault Resilient Boot (FRB) might be kicked to disable a core.

The system can also determine that an error has occurred if the BIOS itself detects the error and indicates the error by generating a new POST code. If the POD manager receives an error-related POST code from the BIOS, then the POD Manager determines that the SLED including the executed BIOS has an error and can react such as notifying the admin to service the SLED.

In one implementation, the PODM determines how much time is spent on each POST sequence and if there are any errors. If the BIOS or firmware changes, the sequence of the POST codes or progress codes may change due to a change in the BIOS init flow. The POD manager can correct its expectations of the sequence and update the relevant data.

If the system determines in S535 that an error has occurred, then the algorithm advances to S540. In S540, the POD manager records the failure. The algorithm then advances to S542.

In S542, the POD manager notifies a service action. For example, the POD manager can instruct the processing core or the chipset to dump its current state. In some implementations, the POD manager can cause a display of an error condition to an administrator or user via a display. The POD manager can optionally cause an audio notification of the error condition via a speaker. The algorithm then advances to S550.

On the other hand, if the system determines in S535 that an error has not occurred, then the algorithm advances to S545. In S545, the processing core determines whether POST has ended.

If processing core determines in S545 that POST has not ended, then the algorithm returns to S515.

On the other hand, if the processing core determines in S545 that POST has ended, then the algorithm advances to S550.

At S550, the algorithm concludes.

In some implementations, there is a filter on the number of messages that the BIOS can generate and send to the out-of-band. Such a filter can increase the system boot speed.

For example, in a fast boot mode, the BIOS can write a 128-bit progress code that contains the APIC ID, a timestamp counter and the functionality number or module number in which the BIOS is executing. In an extended format, the BIOS can write one or more text messages in the progress code. Even in the base format, the number of bits can be reduced based on a maximum number of cores or a maximum time that the BIOS should take to boot (timestamp counter).

The BIOS also can reduce its communication by generalization. For example, the BIOS can indicate only memory init begin and memory init done. This generalization is in contrast to the BIOS indicating memory init begin, initializing memory controller, detecting DIMMs, determining DIMM sizes, interleaving DIMMs, creating address map, existing memory init mode, and so on.

Modifications

In the discussion of the “super” BMC, the cooling operation is described in the context of the operation of fans. However, the cooling operation need not be so limited. For example, the cooling operation can be performed in the context of controlling the path of a flow of a liquid coolant within each drawer.

In the discussion of BIOS debuggability hooks, differences between timestamps were displayed via a display to a user. The method of disclosing these differences is not limited to a display. In other implementations, these differences can be disclosed via an audio system (such as a speaker) or some form of haptic feedback.

Further, operations of the algorithm illustrated in FIG. 5 can be performed by a compute node or a sled management controller, rather than by a BMC.

In one example implementation, the electrical circuits of the FIGURES can be implemented on a board of an electronic device. The board can be a general circuit board that can hold various components of the internal electronic system of the electronic device and, further, provide connectors for other peripherals. More specifically, the board can provide the electrical connections by which the other components of the system can communicate electrically. Processors (inclusive of digital signal processors, microprocessors, and supporting chipsets) and computer-readable non-transitory memory elements can be coupled to the board based on configuration needs, processing demands, and computer designs. Other components such as external storage, additional sensors, controllers for audio/video display, and peripheral devices can be attached to the board as plug-in cards, via cables, or integrated into the board itself. In various implementations, the functionalities described herein can be implemented in emulation form as software or firmware running within one or more configurable (e.g., programmable) elements arranged in a structure that supports these emulation functions. The software or firmware providing the emulation can be provided on non-transitory computer-readable storage medium comprising instructions to allow a processor to carry out those functionalities.

In another example embodiment, the electrical circuits of the FIGURES can be implemented as stand-alone modules (e.g., a device with components and circuitry to perform a specific application or function) or implemented as plug-in modules into application specific hardware of electronic devices. Particular embodiments of the present disclosure may be included in a system on chip (SOC) package, either in part or in whole. An SOC represents an IC that integrates components of a computer or other electronic system into a single chip. It can contain digital, analog, mixed-signal, and often radio frequency functions: all of which may be provided on a single chip substrate. Other embodiments can include a multi-chip-module (MCM), with a plurality of separate ICs located within a single electronic package and to interact closely with each other through the electronic package. In various other embodiments, the digital filters can be implemented in one or more silicon cores in Application Specific Integrated Circuits (ASICs), Field Programmable Gate Arrays (FPGAs), and other semiconductor chips.

The specifications, dimensions, and relationships outlined herein (e.g., the number of processors, logic operations) have only been offered for purposes of example and teaching only. Such information can be varied considerably without departing from the spirit of the present disclosure or the scope of the appended claims. The specifications apply only to one non-limiting example and, accordingly, they should be construed as such. In the foregoing description, example embodiments have been described with reference to particular processor and/or component arrangements. Various modifications and changes can be made to such embodiments without departing from the scope of the appended claims. The description and drawings are, accordingly, to be regarded in an illustrative rather than in a restrictive sense.

With the numerous examples provided herein, interaction can be described in terms of two, three, four, or more electrical components. However, this has been done for purposes of clarity and example only. The system can be consolidated in any manner. Along similar design alternatives, any of the illustrated components, modules, and elements of the FIGURES can be combined in various possible configurations, all of which are clearly within the scope of this Specification. In certain cases, it can be easier to describe one or more of the functionalities of a given set of flows by only referencing a limited number of electrical elements. The electrical circuits of the FIGURES and its teachings are readily scalable and can accommodate a large number of components, as well as more complicated/sophisticated arrangements and configurations. Accordingly, the examples provided should not limit the scope or inhibit the teachings of the electrical circuits as potentially applied to a myriad of other architectures.

In this disclosure, references to various features (e.g., elements, structures, modules, components, steps, operations, characteristics, etc.) included in “one implementation,” “example implementation,” “an implementation,” “another implementation,” “some implementations,” “various implementations,” “other implementations,” and the like are intended to mean that any such features are included in one or more implementations of the present disclosure, but may or may not necessarily be combined in the same implementations.

Some of the operations can be deleted or removed where appropriate, or these operations can be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms can be provided without departing from the teachings of the present disclosure.

Numerous other changes, substitutions, variations, alterations, and modifications can be ascertained to one skilled in the art, and the present disclosure encompasses all such changes, substitutions, variations, alterations, and modifications as falling within the scope of the claims. Optional features of the apparatuses or methods described above can also be implemented, and specifics in the examples can be used anywhere in one or more embodiments.

### EXAMPLES

Example 1is an apparatus for controller consolidation, the apparatus comprising: a baseboard management controller; a first node including a first minicontroller to communicate with the baseboard management controller; and a second node including a second minicontroller to communicate with the baseboard management controller, wherein the baseboard management controller manages the first and second nodes through communication with the first and second minicontrollers.

In Example 2, the apparatus of Example 1 can optionally include the feature that the first minicontroller is to communicate with the baseboard management controller using a system management bus or an Ethernet interface.

In Example 3, the apparatus of any one of Examples 1-2 can optionally include the feature that the baseboard management controller includes a Pooled System Management Engine.

In Example 4, the apparatus of any one of Examples 1-3 can optionally include the feature that the baseboard management controller is to select an interface to accommodate a keyboard, video, or a mouse.

In Example 5, the apparatus of any one of Examples 1-4 can optionally include the features that the second node further includes a fan, the first minicontroller is to transmit an indication to the baseboard management controller that the first node is overheating, and the baseboard management controller is to operate the fan, based on a determination that the first node is overheating.

In Example 6, the apparatus of Example 5 can optionally include the feature that the baseboard management controller is to determine the first node is located closer to a bottom of a rack than the second node.

In Example 7, the apparatus of any one of Examples 1-6 can optionally include the feature that the first node further includes a sensor that detects when the first node is inserted into a rack.

In Example 8, the apparatus of any one of Examples 1-7 can optionally include the feature that the first node and the second node are on a same sled.

In Example 9, the apparatus of any one of Examples 1-8 can optionally include the feature that the first node is a compute node or a storage node.

In Example 10, the apparatus of any one of Examples 1-9 can optionally include the feature that neither the first node nor the second node has its own baseboard management controller.

In Example 11, the apparatus of any one of Examples 1-10 can optionally include the feature that the first minicontroller and the baseboard management controller share data to perform a job defined by a service level agreement (SLA).

In Example 12, the apparatus of any one of Examples 1-11 can optionally include the feature that the apparatus is a computing system.

Example 13 is an apparatus for controller consolidation, the apparatus comprising: a baseboard management controller; a first node including a first means for communicating with the baseboard management controller; and a second node including a second means for communicating with the baseboard management controller, wherein the baseboard management controller manages the first and second nodes through communication with the first means and the second means.

In Example 14, the apparatus of Example 13 can optionally include the feature that the first means communicates with the baseboard management controller using a system management bus or an Ethernet interface.

In Example 15, the apparatus of any one of Examples 13-14 can optionally include the feature that the baseboard management controller includes a Pooled System Management Engine.

In Example 16, the apparatus of any one of Examples 13-15 can optionally include the feature that the baseboard management controller is to select an interface to accommodate a keyboard, video, or a mouse.

In Example 17, the apparatus of any one of Examples 13-16 can optionally include the features that the second node further includes a fan, the first means transmits an indication to the baseboard management controller that the first node is overheating, and the baseboard management controller is to operate the fan, based on a determination that the first node is overheating.

In Example 18, the apparatus of Example 17 can optionally include the feature that the baseboard management controller is to determine the first node is located closer to a bottom of a rack than the second node.

In Example 19, the apparatus of any one of Examples 13-18 can optionally include the feature that the first node further includes a sensor that detects when the first node is inserted into a rack.

In Example 20, the apparatus of any one of Examples 13-19 can optionally include the feature that the first node and the second node are on a same sled.

In Example 21, the apparatus of any one of Examples 13-20 can optionally include the feature that the first node is a compute node or a storage node.

In Example 22, the apparatus of any one of Examples 13-21 can optionally include the feature that neither the first node nor the second node has its own baseboard management controller.

In Example 23, the apparatus of any one of Examples 13-22 can optionally include the feature that the first means and the baseboard management controller share data to perform a job defined by a service level agreement (SLA).

In Example 24, the apparatus of any one of Examples 13-23 can optionally include the feature that the apparatus is a computing system.

Example 25 is a method for controller consolidation, the method comprising: receiving, from a first minicontroller included in a first node, with a baseboard management controller, a first communication; and receiving, from a second minicontroller included in a second node, with the baseboard management controller, a second minicontroller, wherein the baseboard management controller manages the first and second nodes through communication with the first and second minicontrollers.

In Example 26, the method of Example 25 can optionally include the feature that the first minicontroller is to communicate with the baseboard management controller using a system management bus or an Ethernet interface.

In Example 27, the method of any one of Examples 25-26 can optionally include the feature that the baseboard management controller includes a Pooled System Management Engine.

In Example 28, the method of any one of Examples 25-27 can optionally include selecting, with the baseboard management controller, an interface to accommodate a keyboard, video, or a mouse.

In Example 29, the method of any one of Examples 25-28 can optionally include the features that the second node further includes a fan, the first minicontroller is to transmit an indication to the baseboard management controller that the first node is overheating, and the baseboard management controller is to operate the fan, based on a determination that the first node is overheating.

In Example 30, the method of Example 29 can optionally include determining, by the baseboard management controller, that the first node is located closer to a bottom of a rack than the second node.

In Example 31, the method of any one of Examples 25-30 can optionally include receiving, from a sensor associated with the first node, an indication that the first node is inserted into a rack.

In Example 32, the method of any one of Examples 25-31 can optionally include the feature that the first node and the second node are on a same sled.

In Example 32A, the method of any one of Examples 25-32 can optionally include the feature that the first node is a compute node or a storage node.

In Example 32B, the method of any one of Examples 25-32A can optionally include the feature that neither the first node nor the second node has its own baseboard management controller.

In Example 32C, the method of any one of Examples 25-32B can optionally include the feature that the first minicontroller and the baseboard management controller share data to perform a job defined by a service level agreement (SLA).

Example 33 is a machine-readable medium including code that, when executed, causes a machine to perform the method of any one of Examples 25-32C.

Example 34 is an apparatus comprising means for performing the method of any one of Examples 25-32C.

In Example 35, the apparatus of Example 34 can optionally include the feature that the means for performing the method comprise a processor and a memory.

In Example 36, the apparatus of Example 35 can optionally include the feature that the memory comprises machine-readable instructions that, when executed, cause the apparatus to perform the method.

In Example 37, the apparatus of any one of Examples 34-36 can optionally include the feature that the apparatus is a computing system.

Example 38 is at least one computer-readable medium comprising instructions that, when executed, implement the method of any one of Examples 25-32C or realize the apparatus of any one of Examples 34-37.

Example 39 is a non-transitory, tangible, computer-readable storage medium encoded with instructions that, when executed, cause a processing unit to perform a method comprising: receiving, from a first minicontroller included in a first node, with a baseboard management controller, a first communication; and receiving, from a second minicontroller included in a second node, with the baseboard management controller, a second communication, wherein the baseboard management controller manages the first and second nodes through communication with the first and second minicontrollers.

In Example 40, the medium of Example 39 can optionally include the feature of the method further comprising: communicating, with the first minicontroller, by the baseboard management controller, using a system management bus or Ethernet interface.

In Example 41, the medium of any one of Examples 39-40 can optionally include the feature that the baseboard management controller includes a Pooled System Management Engine.

In Example 42, the medium of any one of Examples 39-41 can optionally include the feature of the method further comprising: selecting, by the baseboard management controller, an interface to accommodate a keyboard, video, or a mouse.

In Example 43, the medium of any one of Examples 39-42 can optionally include the features of the method further comprising: receiving, from the first minicontroller, an indication that the first node is overheating; and operating a fan included in the second node, based on a determination that the first node is overheating.

In Example 44, the medium of Example 43 can optionally include the feature of the method further comprising: determining, by the baseboard management controller, that the first node is located closer to a bottom of a rack than the second node.

In Example 45, the medium of any one of Examples 39-44 can optionally include the feature of the method further comprising: receiving, from a sensor included in the first node, an indication that the first node has been inserted into a rack.

In Example 46, the medium of any one of Examples 39-45 can optionally include the feature that the first node and the second node are on a same sled.

In Example 47, the medium of any one of Examples 39-46 can optionally include the feature that the first node is a compute node or a storage node.

In Example 48, the medium of any one of Examples 39-47 can optionally include the feature that the first minicontroller and the second minicontroller are not baseboard management controllers.

In Example 49, the medium of any one of Examples 39-48 can optionally include the feature that the first minicontroller and the baseboard management controller share data to perform a job defined by a service level agreement (SLA).

Example 50 is an apparatus for preventing an inband Basic Input/Output System (BIOS) update in a composed system in a rack scale environment, the apparatus comprising: a processor for a compute node and operable to execute instructions associated with electronic code, such that the processor is to receive a request for an update and to block the update, based on a determination that the update is to firmware of the compute node, to prevent the BIOS update; and a memory element to store the electronic code, wherein the memory element is on the compute node.

In Example 51, the apparatus of Example 50 can optionally include the feature that the processor is to allow the update based on a determination that the compute node is operating in an administrator mode, and the compute node operates in the administrator mode based at least in part on an authentication.

In Example 52, the apparatus of any one of Examples 50-51 can optionally include the feature that the processor is to authorize an operation in an administrator mode, based at least in part on an authentication.

In Example 53, the apparatus of any one of Examples 50-52 can optionally include the feature that the processor is to provide an indication of resources based on a service level agreement, based at least in part on a query of available resources.

In Example 54, the apparatus of any one of Examples 50-53 can optionally include the features that the processor is to provide an indication of available resources, based at least in part on a query of available resources and a determination that the compute node is operating in the administrator mode, and the compute node operates in the administrator mode based at least in part on an authentication.

In Example 55, the apparatus of any one of Examples 50-54 can optionally include the features that the compute node receives an out-of-band message to exit from an administrator mode, and the compute node operates in the administrator mode based at least in part on an authentication.

In Example 56, the apparatus of any one of Examples 50-55 can optionally include the feature that the processor is to block the update based on a determination that the compute node is operating in a user mode.

In Example 57, the apparatus of any one of Examples 50-56 can optionally include the feature that the apparatus is a computing system.

Example 58 is an apparatus for preventing an inband Basic Input/Output System (BIOS) update in a composed system in a rack scale environment, the apparatus comprising: computing means for executing instructions associated with electronic code and for receiving a request for an update and for blocking the update, based on a determination that the update is to firmware of a compute node, to prevent the BIOS update; and means for storing the electronic code.

In Example 59, the apparatus of Example 58 can optionally include the feature that the computing means allows the update based on a determination that the compute node is operating in an administrator mode, and the compute node operates in the administrator mode based at least in part on an authentication.

In Example 60, the apparatus of any one of Examples 58-59 can optionally include the feature that the computing means authorizes an operation in an administrator mode, based at least in part on an authentication.

In Example 61, the apparatus of any one of Examples 58-60 can optionally include the feature that the computing means provides an indication of resources based on a service level agreement, based at least in part on a query of available resources.

In Example 62, the apparatus of any one of Examples 58-61 can optionally include the features that the computing means provides an indication of available resources, based at least in part on a query of available resources and a determination that the compute node is operating in the administrator mode, and the compute node operates in the administrator mode based at least in part on an authentication.

In Example 63, the apparatus of any one of Examples 58-62 can optionally include the features that the computing means receives an out-of-band message to exit from an administrator mode, and the compute node operates in the administrator mode based at least in part on an authentication.

In Example 64, the apparatus of any one of Examples 58-63 can optionally include the feature that the computing means blocks the update based on a determination that the compute node is operating in a user mode.

In Example 65, the apparatus of any one of Examples 58-64 can optionally include the feature that the apparatus is a computing system.

Example 66 is a method for preventing an inband Basic Input/Output System (BIOS) update in a composed system in a rack scale environment: receiving a request for an update; and blocking the update, based on a determination that the update is to firmware of a compute node, to prevent the BIOS update.

In Example 67, the method of Example 66 can optionally include allowing the update based on a determination that the compute node is operating in an administrator mode, wherein the compute node operates in the administrator mode based at least in part on an authentication.

In Example 68, the method of any one of Examples 66-67 can optionally include authorizing an operation in an administrator mode, based at least in part on an authentication.

In Example 69, the method of any one of Examples 66-68 can optionally include providing an indication of resources based on a service level agreement, based at least in part on a query of available resources.

In Example 70, the method of any one of Examples 66-69 can optionally include providing an indication of available resources, based at least in part on a query of available resources and a determination that the compute node is operating in an administrator mode, wherein the compute node operates in the administrator mode based at least in part on an authentication.

In Example 71, the method of any one of Examples 66-70 can optionally include receiving an out-of-band message to exit from an administrator mode, wherein the compute node operates in the administrator mode based at least in part on an authentication.

In Example 72, the method of any one of Examples 66-71 can optionally include blocking the update based on a determination that the compute node is operating in a user mode.

Example 73 is a machine-readable medium including code that, when executed, causes a machine to perform the method of any one of Examples 66-72.

Example 74 is an apparatus comprising means for performing the method of any one of Examples 66-73.

In Example 75, the apparatus of Example 74 can optionally include the feature that the means for performing the method comprise a processor and a memory.

In Example 76, the apparatus of Example 75 can optionally include the feature that the memory comprises machine-readable instructions that, when executed, cause the apparatus to perform the method.

In Example 77, the apparatus of any one of Examples 75-76 can optionally include the feature that the apparatus is a computing system.

Example 78 is at least one computer-readable medium comprising instructions that, when executed, implement the method of any one of Examples 66-71 or realize the apparatus of any one of Examples 74-77.

Example 79 is a non-transitory, tangible, computer-readable storage medium encoded with instructions that, when executed, cause a processing unit to perform a method for preventing an inband Basic Input/Output System (BIOS) update in a composed system in a rack scale environment, the method comprising: receiving a request for an update; and blocking the update, based on a determination that the update is to firmware of a compute node, to prevent the BIOS update.

In Example 80, the medium of Example 79 can optionally include the feature of the method further comprising: allowing the update based on a determination that the compute node is operating in an administrator mode, wherein the compute node operates in the administrator mode based at least in part on an authentication.

In Example 81, the medium of any one of Examples 79-80 can optionally include the feature of the method further comprising: authorizing an operation in an administrator mode, based at least in part on an authentication.

In Example 82, the medium of any one of Examples 79-81 can optionally include the feature of the method further comprising: providing an indication of resources based on a service level agreement, based at least in part on a query of available resources.

In Example 83, the medium of any one of Examples 79-82 can optionally include the feature of the method further comprising: providing an indication of available resources, based at least in part on a query of available resources and a determination that the compute node is operating in an administrator mode, wherein the compute node operates in the administrator mode based at least in part on an authentication.

In Example 84, the medium of any one of Examples 79-83 can optionally include the feature of the method further comprising: receiving an out-of-band message to exit from an administrator mode, wherein the compute node operates in the administrator mode based at least in part on an authentication.

In Example 85, the medium of any one of Examples 79-84 can optionally include the feature of the method further comprising: blocking the update based on a determination that the compute node is operating in a user mode.

Example 86 is an apparatus for implementing debuggability hooks, the apparatus comprising: a memory element operable to store electronic code; and a processor operable to execute instructions associated with the electronic code to assign a first identifier to a first processing core of a plurality of processing cores, to assign a second identifier to a second processing core of the plurality of processing cores, and to receive from one of the plurality of processing cores a first message including a POST code and the first identifier or the second identifier.

In Example 87, the apparatus of Example 86 can optionally include the feature that the first message includes a first timestamp, and the processor is to receive a second message including a second timestamp and to determine a difference between the first timestamp and the second timestamp.

In Example 88, the apparatus of any one of Examples 86-87 can optionally include a POD manager to generate a notification indicating that a sled of the first processing core or a sled of the second processing core has an error, if the difference is greater than a predetermined time based on historical data for the POST code on a previous boot.

In Example 89, the apparatus of any one of Examples 86-88 can optionally include the feature that the processor is a baseboard management controller, a compute node, or a sled management controller.

In Example 90, the apparatus of any one of Examples 86-89 can optionally include the feature that the first message includes a text error code.

In Example 91, the apparatus of any one of Examples 86-90 can optionally include a POD manager that identifies that the first processing core or the second processing core wrote the POST code based at least in part on an Advanced Programmable Interrupt Controller (APIC) ID, and the feature that the first identifier or the second identifier is the processor APIC ID.

In Example 92, the apparatus of any one of Examples 86-91 can optionally include the feature that the apparatus is a computing system.

Example 93 is an apparatus for implementing debuggability hooks, the apparatus comprising: means for storing electronic code; and processing means for assigning a first identifier to a first processing core of a plurality of processing cores, for assigning a second identifier to a second processing core of the plurality of processing cores, and for receiving from one of the plurality of processing cores a first message including a POST code and the first identifier or the second identifier.

In Example 94, the apparatus of Example 93 can optionally include the features that the first message includes a first timestamp, and the processing means receives a second message including a second timestamp and determines a difference between the first timestamp and the second timestamp.

In Example 95, the apparatus of any one of Examples 93-94 can optionally include means for generating a notification indicating that a sled of the first processing core or a sled of the second processing core has an error, if the difference is greater than a predetermined time based on historical data for the POST code on a previous boot.

In Example 96, the apparatus of any one of Examples 93-95 can optionally include the feature that the processing means is a baseboard management controller, a compute node, or a sled management controller.

In Example 97, the apparatus of any one of Examples 93-96 can optionally include the feature that the first message includes a text error code.

In Example 98, the apparatus of any one of Examples 93-97 can optionally include means for identifying that the first processing core or the second processing core wrote the POST code based at least in part on an Advanced Programmable Interrupt Controller (APIC) ID, wherein the first identifier or the second identifier is the processor APIC ID.

In Example 99, the apparatus of any one of Examples 93-98 can optionally include the feature that the apparatus is a computing system.

Example 100 is a method for implementing debuggability hooks, the method comprising: assigning, by a processor, a first identifier to a first processing core of a plurality of processing cores; assigning a second identifier to a second processing core of the plurality of processing cores; and receiving from one of the plurality of processing cores a first message including a POST code and the first identifier or the second identifier.

In Example 101, the method of Example 100 can optionally include receiving a second message, wherein the first message includes a first timestamp, and the second message includes a second timestamp; and determining a difference between the first timestamp and the second timestamp.

In Example 102, the method of any one of Examples 100-101 can optionally include generating a notification indicating that a sled of the first processing core or a sled of the second processing core has an error, if the difference is greater than a predetermined time based on historical data for the POST code on a previous boot.

In Example 103, the method of any one of Examples 100-102 can optionally include the feature that the processor is a baseboard management controller, a compute node, or a sled management controller.

In Example 104, the method of any one of Examples 100-103 can optionally include the feature that the first message includes a text error code.

In Example 105, the method of any one of Examples 100-104 can optionally include identifying that the first processing core or the second processing core wrote the POST code based at least in part on an Advanced Programmable Interrupt Controller (APIC) ID, wherein the first identifier or the second identifier is the processor APIC ID.

Example 106 is a machine-readable medium including code that, when executed, causes a machine to perform the method of any one of Examples 100-105.

Example 107 is an apparatus comprising means for performing the method of any one of Examples 100-105.

In Example 108, the apparatus of Example 107 can optionally include the feature that the means for performing the method comprise a processor and a memory.

In Example 109, the apparatus of Example 108 can optionally include the feature that the memory comprises machine-readable instructions that, when executed, cause the apparatus to perform the method.

In Example 110, the apparatus of any one of Examples 107-109 can optionally include the feature that the apparatus is a computing system.

Example 111 is at least one computer-readable medium comprising instructions that, when executed, implement the method of any one of Examples 100-105 or realize the apparatus of any one of Examples 107-110.

Example 112 is a non-transitory, tangible, computer-readable storage medium encoded with instructions that, when executed, cause a processing unit to perform a method comprising: assigning a first identifier to a first processing core of a plurality of processing cores; assigning a second identifier to a second processing core of the plurality of processing cores; and receiving from one of the plurality of processing cores a first message including a POST code and the first identifier or the second identifier.

In Example 113, the medium of Example 112 can optionally include the feature of the method further comprising: receiving a second message, wherein the first message includes a first timestamp, and the second message includes a second timestamp; and determining a difference between the first timestamp and the second timestamp.

In Example 114, the medium of any one of Examples 112-113 can optionally include the feature of the method further comprising: generating a notification indicating that a sled of the first processing core or a sled of the second processing core has an error, if the difference is greater than a predetermined time based on historical data for the POST code on a previous boot.

In Example 115, the medium of any one of Examples 112-114 can optionally include the feature that the processing unit is a baseboard management controller, a compute node, or a sled management controller.

In Example 116, the medium of any one of Examples 112-115 can optionally include the feature that the first message includes a text error code.

In Example 117, the medium of any one of Examples 112-116 can optionally include the feature of the method further comprising: identifying that the first processing core or the second processing core wrote the POST code based at least in part on an Advanced Programmable Interrupt Controller (APIC) ID, wherein the first identifier or the second identifier is the processor APIC ID.

What is claimed is:

1. An apparatus, comprising:
a baseboard management controller;
a first node including a first minicontroller to communicate with the baseboard management controller; and
a second node including a second minicontroller to communicate with the baseboard management controller, wherein the baseboard management controller manages the first and second nodes through communication with the first and second minicontrollers.

2. The apparatus of claim 1, wherein the first minicontroller is to communicate with the baseboard management controller using a system management bus or an Ethernet interface.

3. The apparatus of claim 1, wherein the baseboard management controller includes a Pooled System Management Engine.

4. The apparatus of claim 1, wherein the baseboard management controller is to select an interface to accommodate a keyboard, video, or a mouse.

5. The apparatus of claim 1, wherein the second node further includes a fan, the first minicontroller is to transmit an indication to the baseboard management controller that the first node is overheating, and the baseboard management controller is to operate the fan, based on a determination that the first node is overheating.

6. The apparatus of claim 5, wherein the baseboard management controller is to determine the first node is located closer to a bottom of a rack than the second node.

7. The apparatus of claim 1, wherein the first node further includes a sensor that detects when the first node is inserted into a rack.

8. The apparatus of claim 1, wherein the first node and the second node are on a same sled.

9. The apparatus of claim 1, wherein the first node is a compute node or a storage node.

10. The apparatus of claim 1, wherein neither the first node nor the second node has its own baseboard management controller.

11. The apparatus of claim 1, wherein the first minicontroller and the baseboard management controller share data to perform a job defined by a service level agreement (SLA).

12. An apparatus for controller consolidation, the apparatus comprising:
means for storing electronic code;
a baseboard management controller;
a first node including a first means for communicating with the baseboard management controller; and
a second node including a second means for communicating with the baseboard management controller, wherein the baseboard management controller manages the first and second nodes through communication with the first means and the second means.

13. A method for controller consolidation, the method comprising:
receiving, from a first minicontroller included in a first node, with a baseboard management controller, a first communication; and
receiving, from a second minicontroller included in a second node, with the baseboard management controller, a second minicontroller, wherein the baseboard management controller manages the first and second nodes through communication with the first and second minicontrollers.

14. The method of claim 13, wherein the first minicontroller is to communicate with the baseboard management controller using a system management bus or an Ethernet interface.

15. The method of claim 13, further comprising:
receiving, from a sensor associated with the first node, an indication that the first node is inserted into a rack.

16. The method of claim 12, wherein the first node and the second node are on a same sled.

17. A non-transitory, tangible, computer-readable storage medium encoded with instructions that, when executed, cause a processing unit to perform a method comprising:
receiving, from a first minicontroller included in a first node, with a baseboard management controller, a first communication; and
communicating, from a second minicontroller included in a second node, with the baseboard management controller, a second communication, wherein the baseboard management controller manages the first and second nodes through communication with the first and second minicontrollers.

18. The medium of claim 17, the method further comprising:
communicating, with the first minicontroller, by the baseboard management controller, using a system management bus or Ethernet interface.

19. The medium of claim 17, the method further comprising:
selecting, by the baseboard management controller, an interface to accommodate a keyboard, video, or a mouse.

20. The medium of claim 17, wherein the first node and the second node are on a same sled.
